(19) United States
(12) Patent Application Publication
(10) Pub. No.: US 2009/0060967 A1
(43) Pub. Date: Mar. 5, 2009

(54) Antimicrobial fiber and method for producing the same thereof

(75) Inventors: Yoshiaki Kamiya, Tokyo (JP); Kenichi Tanaka, Tokyo (JP); Shinobu Kanamaru, Tokyo (JP)

Correspondence Address: KANESAKA BERNER AND PARTNERS LLP, 1700 DIAGONAL RD, SUITE 310, ALEXANDRIA, VA, 22314-2848, US

(73) Assignee: KOA GLASS CO., LTD., Tokyo (JP)

(21) Appl. No.: 11/887,261

(22) PCT Filed: Nov. 17, 2005
(86) PCT No.: PCT/JP2005/021085

§ 371 Date: Sep. 27, 2007

(30) Foreign Application Priority Data
May 10, 2005 (JP) 2005-136940

(51) Int. Cl. A01N 25/34; D01D 5/28; A01P 1/00

(52) U.S. Cl. 424/409; 264/172.11

(57) ABSTRACT

An object of the present invention is to provide an antimicrobial fiber having a diameter of approximately 10 to 30 μm that is superior in surface smoothness, transparency, and others, and a method for producing the same thereof. Provided is an antimicrobial fiber, comprising a transparent resin, an antimicrobial glass, and inorganic particles as a dispersant of the antimicrobial glass, wherein a diameter of the antimicrobial fiber is in the range of 10 to 30 μm, an average particle size of the antimicrobial glass is in the range of 0.1 to 10 μm, an addition quantity of the antimicrobial glass is in the range of 0.1 to 10% by weight with respect to the total weight, an average particle size of the inorganic particles is in the range of 1 to 15 μm, and an addition quantity of the inorganic particles is in the range of 0.1 to 50 parts by weight with respect to 100 parts by weight of the addition quantity of the antimicrobial glass.

### BACKGROUND OF THE INVENTION

1. Field of the Invention

The present invention relates to an antimicrobial fiber and a method for producing the same, and more specifically, to an antimicrobial fiber that contains inorganic particles for a dispersion of an antimicrobial glass and is superior in surface smoothness, transparency, and others, even if it is a fiber having a diameter of approximately 10 to 30 μm, and a method for producing the same.

2. Description of the Related Art

Recently, antimicrobial resin compositions containing an antimicrobial glass for an antimicrobial action in a predetermined amount have been used in various materials such as construction materials, home electric appliances (including TVs, personal computers, cellphones, video cameras and the like), general merchandises, and packaging materials.

A glass water treatment agent capable of eluting Ag ion is disclosed as such an antimicrobial glass in JP62-210098A. In the composition, the glassy water treatment agent contains a monovalent Ag ion in an amount of 0.2 to 1.5 parts by weight as silver oxide in 100 parts by weight of glass, and has a borosilicate-based antimicrobial glass containing B₂O₃ in an amount of 20 to 70 mol % as its glass component. More specifically, an antimicrobial glass containing B₂O₃ in an amount of 20 to 30 mol %, ZnO in an amount of 40 mol %, P₂O₅ in an amount of 30 to 40 mol % and Ag₂O in an amount of 1% by weight, is disclosed in Examples 2 and 3 of the patent publication (see, for example, Patent Document 1).

Alternatively, Patent Document 2 discloses a synthetic resin molded product containing an antimicrobial glass in the resin, as the antimicrobial resin composition. The synthetic resin molded product contains in a resin an antimicrobial glass containing Ag₂O as monovalent Ag in an amount of 0.1 to 20 parts by weight, typical in 100 parts by weight of a glass solid matter composed of one or more network-forming oxides selected from SiO₂, B₂O₃, and P₂O₅ and one or more network-modifying oxides selected from Na₂O, K₂O, CaO, and ZnO. More specifically, an antimicrobial glass containing Ag₂O added in an amount of 2 parts by weight with respect to 100 parts by weight of a mixture of SiO₂ (40 mol %), B₂O₃ (50 mol %), and Na₂O (10 mol %) is disclosed in the Example of the patent publication (see, for example, Patent Document 2).

In addition, the applicant of the present invention had earlier proposed a polyhedral antimicrobial glass having an average particle size of 0.5 to 300 μm that is resistant to yellowing of a soluble glass, superior in transparency and dispersibility, and easier in production (see, for example, Patent Document 3).

### Patent Document 1: JP62-210098A (Claims)

### Patent Document 2: JP01-313531A (Claims)

### Patent Document 3: WO02/28792 (Claims)

However, the antimicrobial glass disclosed in Patent Document 1 contains B₂O₃ in an amount of 20 to 70 mol % as its glass composition, and has a problem that the antimicrobial glass is easily whitened or reaggregated, is lower in transparency and easily yellowed, probably because its favorable shape is not considered. The antimicrobial glass also has a problem of low dispersibility when mixed in a resin.

Thus, the antimicrobial galas lower in transparency and dispersion, when used in production of an antimicrobial fiber having a diameter of approximately 10 to 30 μm, causes a problem of aggregation thereof in the fiber and significant difficulty in spinning.

Alternatively, the antimicrobial glass disclosed in Patent Document 2 contains B₂O₃ as the principal component in its glass composition and has an un-optimized blending rate of a network-forming oxide with a network-modifying oxide, and thus, has problems such as low antimicrobial activity and elongation of the production period due to its glass composition.

When used in production of an antimicrobial fiber having a diameter of approximately 10 to 30 μm, such an antimicrobial glass is also lower in dispersibility, causing aggregation in the fiber and thus prohibiting spinning of the fiber.

Alternatively, the antimicrobial glass disclosed in Patent Document 3 shows superior antimicrobial properties and dispersibility when used in general applications. However, for example, when used in production of an antimicrobial fiber having a diameter of approximately 10 to 30 μm, the antimicrobial glass causes problems such as reaggregation of a soluble glass and exposure of the aggregate on the surface, depending on spinning conditions or the like, and deterioration in surface smoothness and transparency of the resulting antimicrobial fiber.

When used in production of an antimicrobial fiber having a diameter of approximately 10 to 30 μm, such an antimicrobial glass also causes problems such as lower dispersibility of the glass in a transparent resin, causing aggregation in the fiber and prohibiting reliable spinning.

In addition, control of the average particle size and the variation thereof by using a pulvelizer such as a wet ball mill in production of the antimicrobial glasses disclosed in Patent Documents 1 to 3 results in deposition of the antimicrobial glass on the internal surface of the pulvelizer container, causing a problem that the average particle size cannot be controlled practically. When the antimicrobial glass is withdrawn, for example, from a wet ball mill, it should be processed in the drying step, but disadvantageously, the antimicrobial glass aggregates rapidly, forming larger particles, before it is dried.

Accordingly, there has been practically no method of producing an antimicrobial glass having a small average particle size and narrow particle size distribution for use in production of an antimicrobial fiber having a diameter of approximately 10 to 30 μm.

### SUMMARY OF THE INVENTION

After intensive studies, the inventors have found that it is possible to produce an antimicrobial fiber that is dispersible uniformly in an ultrafine antimicrobial fiber having a diameter of approximately 10 to 30 μm reliably by adding particular aggregated inorganic particles as a dispersant (dispersant aid) of an antimicrobial glass and controlling other predetermined conditions in certain ranges, and completed the present invention.

An object of the present invention is to provide an antimicrobial fiber containing an antimicrobial glass superior, for example, in dispersibility in the antimicrobial fiber and production stability and a method for producing the same, and also, an antimicrobial fiber superior, for example, in antimicrobial activity and surface smoothness or transparency and a method for producing the same.

According to an aspect of the present invention, there is provided an antimicrobial fiber comprising a transparent resin, an antimicrobial glass, and inorganic particles as a dispersant of the antimicrobial glass, wherein a diameter of the antimicrobial fiber is in the range of 10 to 30 μm, an average particle size of the antimicrobial glass is in the range of 0.1 to 10 μm, an addition quantity of the antimicrobial glass is in the range of 0.1 to 10% by weight with respect to the total weight, an average particle size of the inorganic particles is in the range of 1 to 15 μm, and an addition quantity of the inorganic particles is in the range of 0.1 to 50 parts by weight with respect to 100 parts by weight of the addition quantity of the antimicrobial glass, and thus, the problems above with the microbial fiber can be solved.

It is thus possible to obtain an antimicrobial glass superior, for example, in dispersibility and transparency, by adding predetermined inorganic particles other than the antimicrobial glass as the dispersant for the antimicrobial glass and also by controlling the addition quantity of the antimicrobial glass, the average particle size, and others in predetermined ranges. Thus, even when used in an ultrafine antimicrobial fiber having a diameter of approximately 10 to 30 μm, the antimicrobial glass is dispersed sufficiently in the fiber, the spinning efficiency is favorable, and thus, it is possible to obtain an antimicrobial fiber superior, for example, in antimicrobial activity and surface smoothness or transparency reliably.

When the inorganic particles are aggregated basically, the average particle size thereof means an average particle size of secondary particles, and, when the inorganic particles are present independently practically, the average particle size means an average particle size of primary particles.

In producing the antimicrobial fiber according to the invention, the inorganic particles are preferably aggregated silica particles.

It is possible to obtain an antimicrobial glass more superior, for example, in dispersibility and transparency cost-effectively and reliably, by using such aggregated silica particles, and further, to obtain an antimicrobial fiber superior in spinning efficiency, surface smoothness and transparency cost-effectively and reliably. Silica particles are more hydrophilic and thus, make a solubilization rate of the antimicrobial glass constant and the color-developing efficiency of the antimicrobial fiber favorable, by deposition on the surface of the antimicrobial glass.

Alternatively in producing the antimicrobial fiber according to the invention, a specific volume resistivity of the inorganic particles is preferably in the range of 1×10⁵ to 1×10⁹ Ω·cm.

It is possible to adjust the specific volume resistivity of the antimicrobial fiber easily and also to obtain an antimicrobial fiber more superior in surface smoothness and transparency reliably by using such inorganic particles in combination with the antimicrobial glass.

In producing the antimicrobial fiber according to the invention, a visible light transmittance of the antimicrobial fiber is preferably 90% or more.

By restricting the visible light transmittance of the antimicrobial fiber, it is possible to estimate the dispersion of the antimicrobial glass and the inorganic particles and to obtain an antimicrobial fiber more superior, for example, in surface smoothness and transparency reliably.

The antimicrobial glass for use in the invention is advantageous in that it is superior in transparency and dispersibility and the visible light transmittance of the antimicrobial fiber can be controlled easily in a predetermined range.

In producing the antimicrobial fiber according to the invention, a specific surface area of the antimicrobial glass is preferably in the range of 10,000 to 300,000 cm²/cm³.

It is possible to obtain an antimicrobial fiber more superior in dispersibility and transparency, and also in mechanical properties reliably by restricting the specific surface area of the antimicrobial glass as described above.

In producing the antimicrobial fiber according to the invention, preferably, an average particle size of the antimicrobial glass is indicated by a 50% volume particle size (D50), a 90% volume particle size (D90) is in the range of 0.5 to 12 μm, and a ratio of D90/D50 is in the range of 1.1 to 2.0.

It is possible to obtain an antimicrobial fiber more superior in dispersibility and transparency, and also in mechanical properties reliably by restricting the volume particle sizes (D50 and D90) of the antimicrobial glass respectively, as they are correlated to each other.

In producing the antimicrobial fiber according to the invention, the antimicrobial glass is preferably surface-treated with a silane coupling agent containing a long-chain alkyl group having 5 or more carbon atoms, forming a hydrophobic group on the surface thereof.

By using such a surface-treated antimicrobial glass, it is possible to make the surface of the antimicrobial glass hydrophobic, control, for example, the average particle size thereof easier during production, and make dispersion of the antimicrobial glass more favorably in the transparent resin.

According to another aspect of the present invention, there is provided a method of producing an antimicrobial fiber comprising a transparent resin, an antimicrobial glass, and inorganic particles as a dispersant of the antimicrobial glass, the method comprising the following steps (A) to (D):

a step (A) of preparing a glass by melting and cooling raw glass materials containing an antimicrobial ion-releasing substance;

a step (B) of preparing an inorganic particle-added antimicrobial glass by pulverizing the obtained glass with a pulvelizer, together with inorganic particles having an average particle size of 0.01 to 5 μm as a dispersant for the antimicrobial glass, into the antimicrobial glass having an average particle size of 0.1 to 10 μm;

a step (C) of dispersing the obtained inorganic particle-added antimicrobial glass in a transparent resin; and

a step (D) of spinning the mixture into an antimicrobial fiber having a diameter of 10 to 30 μm.

It is thus possible to obtain an antimicrobial glass superior, for example, in dispersibility and transparency reliably, by using predetermined inorganic particles in combination as the dispersant of the antimicrobial glass and controlling the average particle size of the antimicrobial glass and others. Thus, even when used for production of an ultrafine antimicrobial fiber having a diameter of approximately 10 to 30 μm, the antimicrobial glass is dispersed sufficiently in the fiber, superior spinning efficiency is obtained, and it is possible to obtain an antimicrobial fiber superior, for example, in antimicrobial activity and surface smoothness or transparency reliably.

In working the method for producing an antimicrobial fiber according to the invention, the pulvelizer is preferably a wet ball mill, a dry ball mill, a planetary mill, a vibrating mill or a jet mill.

In production of an antimicrobial glass by using such a pulvelizer, it is possible to obtain an antimicrobial glass superior, for example, in dispersibility and transparency more reliably, and to obtain an antimicrobial fiber more superior in surface smoothness and transparency and also in mechanical properties reliably.

In particular, use of a dry pulverizer such as a dry ball mill, a planetary mill, a vibrating mill or a jet mill is favorably, because the drying step after pulverization can be eliminated, and it is possible to prevent aggregation of the antimicrobial glass even if it has an average particle size of 0.1 to 10 μm.

Preferably, in working the method of producing an antimicrobial fiber according to the invention, the pulvelizer is equipped with a cyclone, and the inorganic particle-added antimicrobial glass is produced while circulated with the cyclone.

Producing the antimicrobial glass by using such a pulvelizer makes it possible to obtain an antimicrobial glass superior, for example, in dispersibility and transparency more cost-effectively and also to obtain an antimicrobial fiber superior in surface smoothness and transparency and also in mechanical properties reliably.

### BRIEF DESCRIPTION OF THE DRAWINGS

FIG. 1 is a graph showing a particle size distribution of an antimicrobial glass in Example 1;

FIG. 2 is a diagram illustrating a pulverization processing process in a planetary mill;

FIG. 3 is a view illustrating another planetary mill;

FIG. 4 is a graph showing a particle size distribution of an antimicrobial glass in Comparative Example 1; and

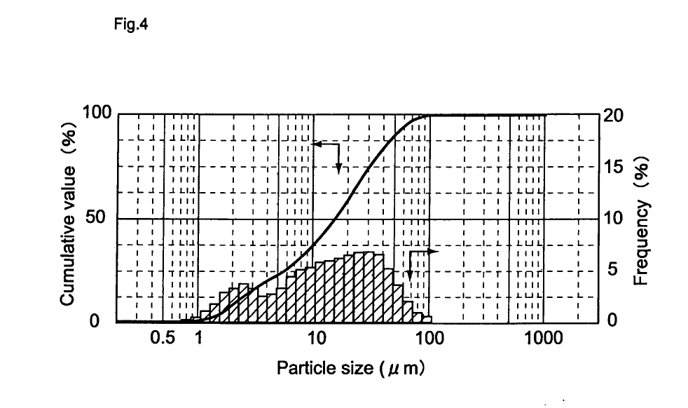

FIG. 5 is a graph showing the particle size distribution of an antimicrobial glass in Comparative Example 2.

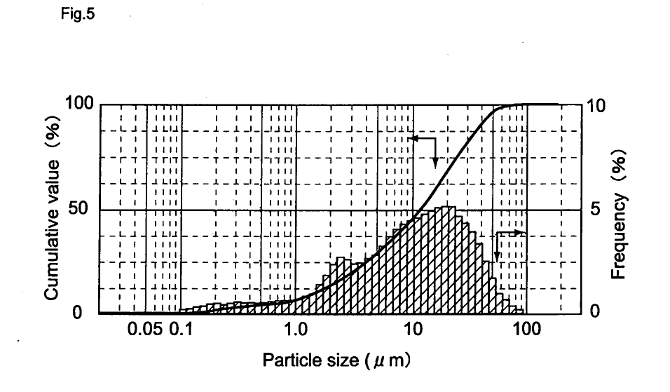

### DESCRIPTION OF THE PREFERRED EMBODIMENTS

### First Embodiment

A first embodiment relates to an antimicrobial fiber comprising a transparent resin, an antimicrobial glass, and inorganic particles as a dispersant of the antimicrobial glass, wherein a diameter of the antimicrobial fiber is in the range of 10 to 30 μm, an average particle size of the antimicrobial glass is in the range of 0.1 to 10 μm, an addition quantity of the antimicrobial glass is in the range of 0.1 to 10% by weight with respect to the total weight, an average particle size of the inorganic particles is in the range of 1 to 15 μm, and an addition quantity of the inorganic particles is in the range of 0.1 to 50 parts by weight with respect to 100 parts by weight of the addition quantity of the antimicrobial glass.

Hereinafter, the antimicrobial glass used in the antimicrobial fiber in the first embodiment, the inorganic particle used in combination, the transparent resin composing the antimicrobial fiber, favorable examples of the antimicrobial fiber and others will be described below specifically.

### 1. Antimicrobial Glass

### (1) Shape

The shape of the antimicrobial glass is preferably polyhedral, i.e., a shape consisting of multiple angles and faces, such as hexahedral to icosahedral.

This is because an antimicrobial glass polyhedral in shape allows transmission of light uniformly on the face in a particular direction, differently from other non-spherical antimicrobial glasses. Thus, it is possible to prevent light scattering caused by the antimicrobial glass effectively and thus, to improve the transparency of the antimicrobial glass.

By making the antimicrobial glass polyhedral, it is also possible to mix and disperse the glass in a resin more readily and to make the antimicrobial glass oriented in a particular direction in an antimicrobial fiber when the fiber is produced, for example, with a spinning machine. It is thus possible to disperse the antimicrobial glass in a resin uniformly easily and to make the resin more transparent, while preventing light scattering from the antimicrobial glass in the resin effectively.

When the shape of the antimicrobial glass is polyhedral, the inorganic particles used in combination are more adhesive thereto and the antimicrobial glass is resistant to reaggregation, for example, during production or during use. This makes it easier to adjust the average particle size of the antimicrobial glass and control dispersion thereof during production.

However, in the first embodiment and the embodiments below, the content of the polyhedron glass is not necessarily 100% by weight. The polyhedron glass is also used favorably in combination with another antimicrobial or non-antimicrobial spherical glass, a granular glass, or an irregular-shaped glass.

In such a case, the content of the polyhedron glass is preferably 80% by weight or more. This is because a polyhedron glass content of less than 80% by weight may lead to deterioration in dispersibility and transparency of the resin. Thus, for more favorable dispersion and transparency, the content of the polyhedron glass is more preferably 90% by weight or more and still more preferably 95% by weight or more.

### (2) Average Particle Size

An average particle size of the antimicrobial glass (D50) is characteristically in the range of 0.1 to 10 μm.

When an entire cumulative volume of an antimicrobial glass is 100% and a particle size at a cumulative volume of 50% is designated as D50 (μm) and used as the average particle size of the particles, the antimicrobial glass is produced while the D50 is controlled in a predetermined range.

This is because an antimicrobial glass having an average particle size (D50) of less than 0.1 μm is resistant to dispersion in a resin and easily causes light scattering, leading to deterioration in transparency.

On the other hand, an antimicrobial glass having an average particle size (D50) of more than 10 μm is resistant to dispersion in a resin and makes handling more difficult, or may lead to significantly deterioration in surface smoothness, transparency, as well as mechanical strength during production of an ultrafine antimicrobial fiber.

For that reason, the average particle size (D50) of the antimicrobial glass is preferably in the range of 0.5 to 8 μm, more preferably in the range of 0.8 to 3 μm.

The average particle size (D50) of the antimicrobial glass, a 90% volume particle size (D90) described below, and the content of the antimicrobial glass having a predetermined particle size can be calculated respectively from a particle size distribution obtained by using a laser particle counter or a sedimentation particle size distribution analyzer or a particle size distribution obtained by image processing of an electron microgram of the antimicrobial glass.

As for the average particle size (D50) of the antimicrobial glass, the 90% volume particle size (D90) is preferably in the range of 0.5 to 12 μm, and a ratio of D90/D50 is preferably in the range of 1.1 to 2.0.

This is because, a D90/D50 ratio of less than 1.1 may make it difficult to disperse the glass in a transparent resin or may cause easier light scattering, leading to deterioration in transparency, while on the other hand, a D90/D50 ratio of more than 2.0 may make dispersion or handling in a transparent resin difficult or lead to deterioration in the surface smoothness of the obtained antimicrobial fiber.

For that reason, the ratio of D90/D50 of the antimicrobial glass is more preferably in the range of 1.2 to 1.9, still more preferably in the range of 1.3 to 1.8.

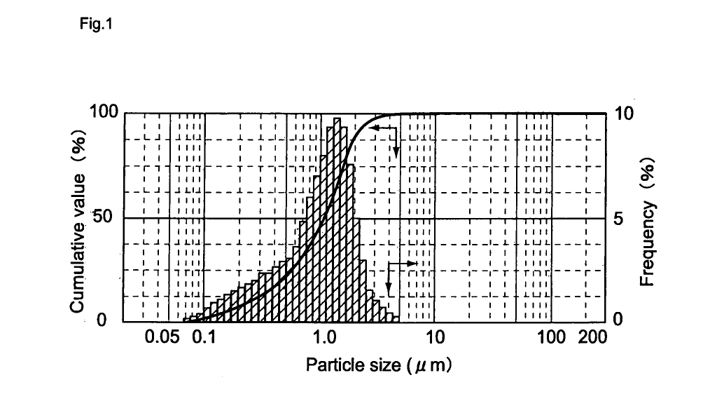

The antimicrobial glass having the particle size distribution exemplified in FIG. 1, which has a D90 in the range of 0.5 to 12 μm and a D90/D50 ratio in the range of 1.1 to 2.0, is known to be miscible easily and uniformly in a resin and give an antimicrobial fiber superior in surface smoothness.

As for the average particle size (D50) of the antimicrobial glass, the rate of particles having a particle size of 10 μm or more is preferably present in an amount of 10 vol % or less with respect to the total weight.

This is because increase in the content of the antimicrobial glass particles having an excessively large particle size often results in easier core formation by the particles during reaggregation. Thus, by controlling the content of such large antimicrobial glass particles to a predetermined value or less, it is possible to improve the dispersibility of the desirable antimicrobial glass in a resin and to give superior surface smoothness without clogging of the molding machine.

As for the average particle size (D50) of the antimicrobial glass, the content of the particles having a particle size of 0.1 μm or less is preferably 5 vol % or less with respect to the total weight.

This is because increase in the content of the antimicrobial glass particles having an excessively small particle size often results in easier reaggregation. Thus, by controlling the content of the easily reaggregating antimicrobial glass particles to a predetermined value or less in the region surrounding the core antimicrobial glass, it is possible to improve the dispersibility of the desirable antimicrobial glass in a resin and to give superior surface smoothness without clogging of the molding machine.

It is known that the reaggregation of the antimicrobial glass having the particle size distribution exemplified in FIG. 1 is rare when mixed with a transparent resin, if the content of particles having a particle size or 10 μm or more and the content of particles having a particle size of 0.1 μm or less are respectively 1 vol % or less.

### (3) Specific Surface Area

A specific surface area of the antimicrobial glass is preferably in the range of 10,000 to 300,000 cm²/cm³.

It is because a glass having a specific surface area of less than 10,000 cm²/cm³ is resistant to dispersion and handling in a transparent resin or may lead to deterioration in surface smoothness and mechanical strength when an antimicrobial fiber is formed.

On the other hand, a glass having a specific surface area of more than 300,000 cm²/cm³ is rather difficult in handling and easier in dispersion in a transparent resin or causes light scattering easily, leading to deterioration in transparency.

For that reason, the specific surface area of the antimicrobial glass is more preferably in the range of 15,000 to 200,000 cm²/cm³ and still more preferably in the range of 18,000 to 150,000 cm²/cm³.

The specific surface area of the antimicrobial glass (cm²/cm³) can be determined from the results of particle size distribution measurement, and calculated as a surface area (cm²) per unit volume (cm³) from the measured data of particle size distribution, assuming that the antimicrobial glass is spherical.

### (4) Glass Composition 1

The antimicrobial glass preferably contains Ag₂O, ZnO, CaO, B₂O₃ and P₂O₅ in its glass composition, and the content of Ag₂O is preferably in the range of 0.2 to 5% by weight with respect to 100% by weight of the total weight; the content of ZnO, in the range of 1 to 50% by weight; the content of CaO, in the range of 0.1 to 15% by weight; the content of B₂O₃, in the range of 0.1 to 15% by weight; the content of P₂O₅, in the range of 30 to 80% by weight; and the rate of ZnO/CaO by weight, in the range of 1.1 to 15.

Here, Ag₂O is an essential constituent component as an antimicrobial ion-releasing substance in the glass composition 1, and presence of Ag₂O allows gradual elution of Ag ion at a predetermined speed when the glass component is dissolved, giving superior antimicrobial activity for an extended period of time.

The content of Ag₂O is preferably in the range of 0.2 to 5% by weight. This is because the antimicrobial activity of the antimicrobial glass is insufficient at an Ag₂O content of less than 0.2% by weight and a greater amount of the antimicrobial glass is needed for obtaining a predetermined antimicrobial effect, while on the other hand, an Ag₂O content of more than 5% by weight results in easier discoloration of the antimicrobial glass and increase in production cost, and thus is disadvantageous economically.

Alternatively, P₂O₅, an essential constituent component in the glass composition 1, fundamentally has a function as a network-forming oxide, and in addition, a function to improve the transparency of the antimicrobial glass and to allow uniform release of Ag ion in the invention.

The content of P₂O₅ is preferably in the range of 30 to 80% by weight. This is because a P₂O₅ content of less than 30% by weight may lead to deterioration in the transparency of the antimicrobial glass, uniform releasing efficiency of Ag ion, or mechanical strength, while a P₂O₅ content of more than 80% by weight may lead to yellowing of the antimicrobial glass and deterioration in hardening efficiency and mechanical strength.

Alternatively, ZnO, an essential constituent component in the glass composition 1, has a function as a network-modifying oxide in the antimicrobial glass and also a function to prevent yellowing and improve the antimicrobial activity.

The content of ZnO is preferably in the range of 2 to 60% by weight with respect to the total weight. This is because a ZnO content of less than 2% by weight may not be effective in preventing yellowing or improving the antimicrobial activity, while a ZnO content of more than 60% by weight may lead to deterioration in the transparency and mechanical strength of the antimicrobial glass.

The content of ZnO is preferably determined, by taking a CaO content described below into consideration. Specifically, the weight rate of ZnO/CaO is preferably in the range of 1.1 to 15. This is because a weight ratio of less than 1.1 may lead to insufficient prevention of yellowing of the antimicrobial glass, while a weight ratio of more than 15 may lead to whitening or yellowing of the antimicrobial glass.

Yet alternatively, CaO, an essential constituent component in the glass composition 1, basically has a function as a network-modifying oxide and is also effective in reducing the heating temperature and preventing yellowing together with ZnO during preparation of the antimicrobial glass.

The content of CaO is preferably in the range of 0.1 to 15% by weight with respect to the total weight. This is because a CaO content of less than 0.1% by weight may lead to deterioration in the yellowing-preventing function and melting temperature-lowering effect, while a CaO content of more than 15% by weight may lead to deterioration in the transparency of the antimicrobial glass.

Yet alternatively, B₂O₃, an essential constituent component in the glass composition 1, basically has a function as a network-forming oxide and in addition, a function to improve the transparency of the antimicrobial glass in the invention, and is also involved in uniform release of Ag ion.

The content of B₂O₃ is preferably in the range of 0.1 to 15% by weight. This is because a B₂O₃ content of less than 0.1% by weight may lead to uniform releasing efficiency of Ag ion and mechanical strength, while a B₂O₃ content of more than 15% by weight may lead to easier yellowing of the antimicrobial glass or deterioration in hardening efficiency and mechanical strength.

CeO₂, MgO, Na₂O, Al₂O₃, K₂O, SiO₂, BaO, or the like may be added as an arbitrary constituent component in the glass composition 1 in an amount favorable in the scope of the present invention.

### (5) Glass Composition 2

Alternatively, the antimicrobial glass preferably contains Ag₂O, CaO, B₂O₃ and P₂O₅ but not ZnO substantially as its glass composition, and the content of Ag₂O is preferably in the range of 0.2 to 5% by weight with respect to 100% by weight of the total weight; the content of CaO, in the range of 15 to 50% by weight; the content of B₂O₃, in the range of 0.1 to 15% by weight; the content of P₂O₅, in the range of 30 to 80% by weight; and the weight rate of CaO/Ag₂O, in the range of 5 to 15.

The Ag₂O is the same as that described in the glass composition 1. Thus, the content of Ag₂O is preferably in the range of 0.2 to 5% by weight with respect to the total weight.

Alternatively, CaO used in the antimicrobial glass basically has a function as a network-modifying oxide and is also effective in reducing the heating temperature during preparation of the antimicrobial glass and preventing yellowing.

For that reason, the content of CaO is preferably in the range of 15 to 50% by weight with respect to the total weight. This is because a CaO content of less than 15% by weight may lead to deterioration in yellowing-preventing function and melting temperature-lowering effect because there is substantially no ZnO contained, while a CaO content of more than 50% by weight to deterioration in the transparency of the antimicrobial glass.

The content of CaO is preferably determined, by taking the content of Ag₂O into consideration, and specifically, the weight ratio of CaO/Ag₂O is preferably in the range of 5 to 15.

The B₂O₃ and P₂O₅ are the same as those described in the glass composition 1.

The components such as CeO₂, MgO, Na₂O, Al₂O₃, K₂O, SiO₂, and BaO are also the same as those described in the glass composition 1.

### (6) Surface Treatment

The antimicrobial glass is preferably finished with a coupling agent on the surface thereof. This is because, by the coupling agent treatment, it is possible to obtain more favorable yellowing resistance, transparency, and dispersibility and also to obtain favorable surface smoothness, independently of the kind of the molding machine for the antimicrobial fiber.

The coupling agent for use may be a silane coupling agent, an aluminum coupling agent, a titanium coupling agent, or the like, and use of a silane coupling agent is preferable because it is particularly favorably adhesive to the antimicrobial glass.

Preferable examples of the silane coupling agent include γ-aminopropyltrimethoxysilane, γ-aminopropyltriethoxysilane, γ-glycidoxypropyltrimethoxysilane, γ-glycidoxypropyltriethoxysilane, γ-mercaptopropyltrimethoxysilane, γ-mercaptopropyltriethoxysilane, octyltrimethoxysilane, octyltriethoxysilane, decyltrimethoxysilane, and decyltriethoxysilane, which may be used alone or in combination of two or more thereof.

It is particularly preferably surface-treated as the hydrophobic group, with a silane coupling agent having a long-chain alkyl group of 5 or more carbon atoms such as octyltrimethoxysilane, octyltriethoxysilane, decyltrimethoxysilane, or decyltriethoxysilane.

Surface treatment of the antimicrobial glass gives an antimicrobial glass having hydrophobic surface, which makes the control, for example, of an average particle size easier during production and thus makes the antimicrobial glass dispersed favorably in the transparent resin. Accordingly, it is possible to obtain an antimicrobial fiber more favorable in surface smoothness and transparency and also in mechanical properties reliably.

The amount of the coupling agent used for surface treatment is preferably in the range of 0.01 to 30 parts by weight with respect to 100 parts by weight of the antimicrobial glass.

This is because it is possible to obtain desired transparency and dispersion and the process is also advantageous economically when such an amount of the coupling agent is used for treatment.

### (7) Elution Rate

The elution rate of the antimicrobial ion from the antimicrobial glass is preferably in the range of 1×10² to 1×10⁵ mg/Kg/24 Hr.

This is because an antimicrobial-ion elution rate of less than 1×10² mg/Kg/24 Hr may reduce the antimicrobial activity drastically, while an antimicrobial-ion elution rate of more then 1×10⁵ mg/Kg/24 Hr may prohibit continuation of the antimicrobial action for a prolonged period of time or lead to deterioration in transparency of the antimicrobial fiber obtained. Thus, for more favorable balance between the antimicrobial activity and transparency and others, the elution rate of the antimicrobial ion from the antimicrobial glass is more preferably in the range of 1×10³ to 5×10⁴ mg/Kg/24 Hr and still more preferably in the range of 3×10³ to 1×10⁴ mg/Kg/24 Hr. The elution rate of the antimicrobial ion can be determined according to the method described below in Example 1.

### (8) Addition Quantity

The addition quantity of the antimicrobial glass is characteristically in the range of 0.1 to 10% by weight with respect to the total weight.

This is because an antimicrobial-glass addition quantity of less than 0.1% by weight may lead to deterioration in antimicrobial activity, while an antimicrobial-glass addition quantity of more than 10% by weight may lead to deterioration in mechanical strength of the antimicrobial fiber, difficulty in mixing uniformly, and deterioration in transparency of the antimicrobial fiber obtained.

Thus, for more favorable balance between the antimicrobial activity and the mechanical strength and others, the addition quantity of the antimicrobial glass is preferably in the range of 0.5 to 8% by weight, still more preferably in the range of 1 to 5% by weight, with respect to the total weight.

### 2. Inorganic Particles

### (1) Kind

The kind of the inorganic particle is not particularly limited, and examples thereof include aggregated silica particles (dry and wet silica), titanium oxide, zinc oxide, aluminum oxide, zirconium oxide, calcium carbonate, Silas balloon, quartz particle, and glass balloon, which may be use alone or in combination of two or more thereof.

In particular among them, an aggregated silica particle (dry or wet silica) or its water dispersion colloidal silica is a preferably inorganic particle because it has a smaller primary average particle size and is dispersible in the antimicrobial glass quite favorably. The aggregated silica particles are dispersed while the aggregation thereof is disintegrated, allowing uniform dispersion of the antimicrobial glass even in the transparent resin, as they deposit on the surface of the antimicrobial glass.

Accordingly, use of inorganic particles having an aggregating tendency (P), which is defined by the following Formula (1), in the range of 100 to 10,000 is preferable, and use of inorganic particles having an aggregating tendency (P) in the range of 500 to 5,000 is more preferable:

P=B/A (1)

where, A is a volume-averaged particle size (D50) of primary particles obtained by complete pulverization of silica particles in the slurry state by use of an wet pulverizer; and B is a volume-averaged particle size (D50) of secondary particles obtained by complete pulverization of silica particles in the slurry state by use of a dry pulverizer.

### (2) Average Particle Size

The average particle size (D50) of the inorganic particles is characteristically in the range of 1 to 15 μm when they are not aggregated basically, while the average particle size (D50) of the secondary particles of the inorganic particle is in the range of 1 to 15 μm when they are aggregated.

Thus, assuming that when the cumulative total volume of the inorganic particles is 100%, the particle size at a cumulative volume of 50% is defined as D50 (μm), the value is controlled in a predetermined range as the average particle size.

This is because an average particle size (D50) of the inorganic particles of less than 1 μm may lead to deterioration in dispersibility of the antimicrobial glass, easily causing light scattering and reducing transparency, while on the other hand, an average particle size (D50) of the inorganic particles of more than 15 μm may lead to deterioration in dispersibility and handling efficiency in a transparent resin similarly, or to drastic deterioration in surface smoothness, transparency, and mechanical strength in production of an ultrafine antimicrobial fiber.

For that reason, the average particle size (D50) of the inorganic particles is more preferably in the range of 5 to 12 am, still more preferably in the range of 6 to 10 μm.

The average particle size of the inorganic particles (or secondary inorganic particles) can be determined by using a laser particle counter or a sedimentation particle size distribution analyzer. The average particle size of the inorganic particles (or secondary inorganic particles) can also be calculated from the electron micrograph by image processing.

When the inorganic particles are basically aggregated, the average particle size of the primary particles after deaggregation is preferably in the range of 0.005 to 0.5 μm.

This is because, when the average particle size (D50) of the inorganic particles as primary particles is less than 0.005 μm, the particles are less effective in improving the dispersibility of the antimicrobial glass, there by causing light scattering and reducing transparency.

On the other hand, when the average particle size (D50) of the inorganic particles as primary particles is more than 0.5 μm, the particles similarly are less effective in improving the dispersibility of the antimicrobial glass, thereby making the dispersion and handling in a transparent resin more difficult similarly in production of an ultrafine antimicrobial fiber, and reducing surface smoothness, transparency, and also mechanical strength.

For that reason, the average particle size (D50) of the inorganic particles as primary particles is more preferably in the range of 0.01 to 0.2 μm, still more preferably in the range of 0.02 to 0.1 μm.

### (3) Addition Quantity

The addition quantity of the inorganic particles is preferably in the range of 0.1 to 50 parts by weight with respect to 100 parts by weight of the antimicrobial glass.

This is because the dispersibility of the antimicrobial glass declines significantly when the addition quantity of the inorganic particles is less than 0.1 parts by weight, while on the other hand, when the addition quantity of the inorganic particles is more than 50 parts by weight, the mechanical strength of the antimicrobial fiber declines and uniform blending becomes more difficult, or the transparency of the antimicrobial fiber obtained may decline.

Accordingly, for more favorable balance between the dispersibility of the antimicrobial glass and the mechanical strength and others, the addition quantity of the inorganic particles is more preferably in the range of 0.5 to 30 parts by weight, still more preferably in the range of 1 to 10 parts by weight, with respect to 100 parts by weight of the antimicrobial glass.

### (4) Specific Volume Resistivity

A specific volume resistivity of the inorganic particles is preferably in the range of 1×10⁵ to 1×10⁹ Ω·cm.

This is because, when the specific volume resistivity of the inorganic particles is less than 1×10⁵ Ω·cm, it may become more difficult to adjust the specific volume resistivity of the antimicrobial fiber, leading to deterioration in mechanical strength when added to an antimicrobial fiber, difficulty of uniform blending, or deterioration in transparency of the antimicrobial fiber obtained. On the other hand, a specific volume resistivity of the inorganic particles of more than 1×10⁹ Ω·cm may generate electrostatic charge in production of the antimicrobial fiber, forcing drastic reduction of the spinning velocity.

Accordingly, for more favorable balance between the mechanical strength etc. of the antimicrobial fiber and resistance to generation of electrostatic charge, the specific volume resistivity of the inorganic particles is more preferably in the range of 5×10⁵ to 5×10⁸ Ω·cm, still more preferably in the range of 1×10⁶ to 1×10⁸ Ω·cm.

The specific volume resistivity of the inorganic particles can be adjusted in a particular range, by using the surface-finishing agent described above such as a silane coupling agent, an aluminum coupling agent, or a titanium coupling agent.

### 3. Transparent Resin

In production of the antimicrobial fiber, the antimicrobial glass is preferably added and blended in a transparent resin.

Preferable examples of the transparent resins include a polyethylene resin, a polypropylene resin, a polyethylene terephthalate resin, a polybutylene terephthalate resin, a polycarbonate resin, a styrenic resin, a vinylidene chloride resin, a vinyl acetate resin, a polyvinylalcohol resin, a fluorine resin, a polyarylene resin, an acrylic resin, an epoxy resin, a polyvinyl chloride resin, an ionomer resin, a poly-amide resin, a polyacetal resin, and silicone resin, which may be used alone or in combination of two or more thereof.

Specifically, among the transparent resins above, a resin having a visible light transmittance, as defined by the following formula, of 80 to 100%, preferably, having a visible light transmittance of 90 to 100%, is more preferable as the fiber resin.

The intensity of the incident and transmitted light to and from a transparent resin can be determined by using a light absorption photometer or an actinometer (power meter). A plate-shaped transparent resin, for example, of 1 mm in thickness, is used during the measurement.

Visible light transmittance (%): Transmitted light intensity/Incident light intensity×100

### 4. Antimicrobial Fiber

### (1) Diameter

A diameter of the antimicrobial fiber is characteristically in the range of 10 to 30 μm.

This is because when the diameter of the antimicrobial fiber is less than 10 μm, the mechanical strength of the antimicrobial fiber declines, or reliable production is made difficult, while on the other hand, the antimicrobial fiber having a diameter of more than 30 μm is restricted in its application significantly.

For that reason, the diameter of the antimicrobial fiber is more preferably in the range of 12 to 25 μm, still more preferably in the range of 15 to 20 μm.

The diameter of the antimicrobial fiber can be determined by using an electron microscope, a micrometer, or a vernier caliper.

### (2) Visible Light Transmittance

The visible light transmittance of the antimicrobial fiber is preferably 90% or more.

This is because it is possible to obtain an antimicrobial fiber more superior in surface smoothness, transparency, and mechanical properties reliably, by restricting the visible light transmittance of the antimicrobial fiber.

This is also because a visible light transmittance of the antimicrobial fiber of less than 90% may lead to drastic deterioration of the color-developing efficiency or the like and significant change in the texture of the antimicrobial fiber.

Thus, for more favorable balance between the mechanical strength and others and the electrostatic properties of the antimicrobial fiber, the visible light transmittance of the antimicrobial fiber is more preferably in the range of 95% or more, and still more preferably in the range of 98% or more.

The visible light transmittance of the antimicrobial fiber can also be determined similarly to the transparent resin described above.

### (3) Additive

Additives are preferably added to the antimicrobial fiber. Examples of the additives include a coloring agent, an antistatic agent, an antioxidant, a fluidizing agent, a viscosity modifier, metal particles, a crosslinking agent, and a flame retardant, which may be used alone or in combination of two or more thereof.

In particular, the antimicrobial fiber according to the present invention is characteristically superior in color-developing efficiency to that without additives, probably because it contains a hydrophilic antimicrobial glass and inorganic particles in predetermined amounts.

### Second Embodiment

Described in a second embodiment is a method of producing an antimicrobial fiber comprising a transparent resin, an antimicrobial glass, and inorganic particles as a dispersant of the antimicrobial glass, the method comprising the following steps (A) to (D):

a step (A) of preparing a glass by melting and then cooling raw glass materials containing an antimicrobial ion-releasing substance;

a step (B) of preparing an inorganic particle-added antimicrobial glass by pulverizing the obtained glass with a pulvelizer, together with inorganic particles having an average particle size of 1 to 15 μm as a dispersant for the antimicrobial glass, into the antimicrobial glass having an average particle size of 0.1 to 10 μm;

a step (C) of dispersing the obtained inorganic particle-added antimicrobial glass in a transparent resin; and

a step (D) of spinning the mixture into an antimicrobial fiber having a diameter of 10 to 30 μm.

### (1) Step of Mixing, Melting and Cooling Raw Glass Materials (Step A)

It is a step of accurately weighing raw glass materials (glass composition 1) including Ag₂O, ZnO, CaO, B₂O₃, P₂O₅, and others, or raw glass materials (glass composition 2) including Ag₂O, CaO, B₂O₃, P₂O₅ and others, but substantially no ZnO, and mixing them uniformly. A mixing machine (mixer) such as a universal stirrer (planetary mixer), an alumina ceramics grinding machine, a ball mill, or a propeller mixer is favorably used in mixing these raw glass materials. For example, in the case of a universal stirrer, it is used in agitating and mixing the raw glass materials at a revolution frequency of 100 rpm and a rotation frequency of 250 rpm for 10 minute to 3 hours.

Then, the uniformly mixed raw glass materials are melted, for example, with a glass melting furnace, to give a melt glass. As for the melting condition, for example, the melting temperature is preferably in the range of 1,100 to 1,500° C., and the melting period is preferably in the range of 1 to 8 hours. This is because the melting condition above is effective in improving the productivity of the melt glass and preventing yellowing of the antimicrobial glass during production as much as possible.

The melt glass thus obtained is then, preferably poured into and cooled in running water, for pulverization in water.

### (2) Step of Pulverizing Antimicrobial Glass (Step B)

It is a step of pulverizing the obtained glass into a polyhedral antimicrobial glass having a predetermined average particle size.

Specifically, it is a step of performing the coarse, medium, and fine pulverization shown below. It is possible to obtain an antimicrobial glass having a uniform average particle size in the step above. However, a classification step, for example by screening, may be installed favorably after the pulverization step, for more accurate control of the average particle size according to the application of the product.

### (2)-1 Coarse Pulverization

Coarse pulverization is a step of pulverizing the glass to an average particle size of approximately 10 mm. The coarse pulverization is a step of pulverizing glass to a predetermined average particle size, for example, by water granulation of a melt glass in a molten state or pulverization of amorphous glass by hand or with a hammer or the like.

Electron micrographic analysis shows that the antimicrobial glass after coarse pulverization is normally bulky particles without sharp edges.

### (2)-2 Intermediate Pulverization

Intermediate pulverization is a step of pulverizing the antimicrobial glass after coarse pulverization to an average particle size of approximately 1 mm.

More specifically, for example, the antimicrobial glass having an average particle size of about 10 mm is preferably pulverized to an antimicrobial glass having an average particle size of about 5 mm by use of a jaw crusher, and the resultant antimicrobial glass is then pulverized further, for example, with a revolving mortar or a revolving roll (roll crusher), to an antimicrobial glass having an average particle size of about 1 mm. This is because it is possible to obtain an antimicrobial glass having a particular particle size effectively, without generation of antimicrobial glasses having an excessively smaller particle size by conducting pulverization in multiple steps.

Electron micrographic analysis confirms that the antimicrobial glass after intermediate pulverization is polyhedral with sharp edges.

### (2)-3 Fine Pulverization

Fine pulverization is a step of pulverizing the antimicrobial glass after intermediate pulverization into particles having an average particle size of 0.1 to 10 μm, together with inorganic particles having an average particle size of 1 to 15 μm. For example, a revolving mortar, a revolving roll (roll crusher), a vibrating mill, a ball mill, a planetary mill, a sand mill, or a jet mill may be used for such fine pulverization.

Among these pulvelizers, use of a ball mill, a planetary mill or a jet mill is particularly preferable.

This is because use of the ball mill, planetary mill, or the like makes it possible to apply a shearing force to a suitable degree, thereby avoiding generation of antimicrobial glasses with an excessively smaller particle size, with the result of obtaining a polyhedral antimicrobial glass having a particular particle size effectively.

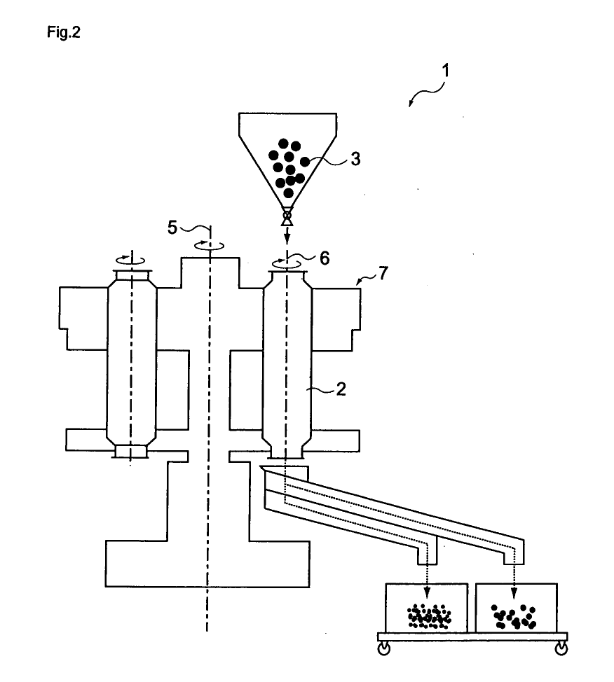

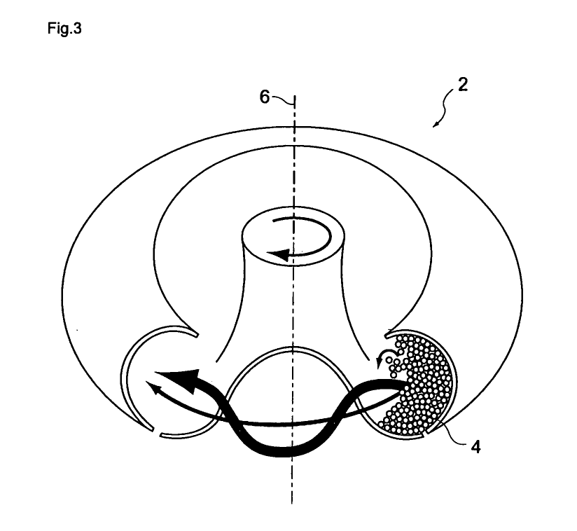

The ball mill is a generic term for the pulvelizers of placing a pulverization medium, a material to be pulverized, and a solvent in a container to pulverize the material to be pulverized by rotating the container in the wet state. The planetary mill is a generic term for the pulvelizers of placing a material 3 to be pulverized in a pulverization container 2 having a rotating shaft 5 and a revolving shaft 6 extending in directions perpendicular to each other as shown in FIGS. 2 and 3 thereby to pulverize the material by rotating the container. The jet mill is a generic term for the pulvelizers of pulverizing materials to be pulverized by collision thereof without using a pulverization medium in a container.

More specifically, when a ball or a planetary mill is used, it is preferable that an alumina ball is used as a pulverization medium 4, the container is rotated at 30 to 100 rpm, and the antimicrobial glass after intermediate pulverization is treated for 5 to 50 hours. Alternatively when a jet mill is used, the antimicrobial glasses after intermediate pulverization are preferably collided to each other, as they are accelerated in the container under a pressure of 0.61 to 1.22 MPa (6 to 12 Kgf/cm²).

Electron micrographic analysis and particle size distribution measurement confirm that the antimicrobial glass after fine pulverization in a ball mill, a jet mill, or the like is polyhedral with even sharper edges than the antimicrobial glass after intermediate pulverization, and thus, the average particle size (D50) and the specific surface area thereof are easily adjusted respectively in predetermined ranges.

The fine pulverization, when a planetary mill or the like is used, is preferably performed in the substantially dry state (for example, at a relative humidity of 20% Rh or less).

This is because it is possible to circulate the antimicrobial glass without aggregation, by installing a classifier such as a cyclone to the planetary mill or the like.

Thus, adjusting the circulation number makes it possible to adjust the average particle size and the particle size distribution of the antimicrobial glass in predetermined ranges easily and to eliminate the drying step after fine pulverization.

On the other hand, an antimicrobial glass having a diameter in a predetermined range or less can be removed, for example, by using a bag filter if it is in the dry state. This makes it easier to control the average particle size and the particle size distribution of the antimicrobial glass.

### (3) Step of Producing Antimicrobial Fiber (Step C)

It is a step of dispersing the obtained antimicrobial glass in a transparent resin and spinning the mixture into a particular shape, to form an antimicrobial fiber.

First, the method of dispersing the obtained polyhedral antimicrobial glass in a transparent resin is not particularly limited, and examples thereof include agitating mixing, kneading, coating, and diffusion. For example, in the case of agitating mixing, the mixture is preferably blended and agitated at normal temperature (25° C.) for 1 to 20 minutes. When the antimicrobial glass is mixed, a mixing machine such as a propeller mixer, a V-blender, or a kneader is preferably used.

Then, the kind of the molding machine for use in spinning the glass into a predetermined shape is not particularly limited, and preferable examples thereof include a BMC (bulk molding compound) injection molding machine, an SMC (sheet molding compound) compression molding machine, a BMC (bulk molding compound) compression molding machine, and a pressing machine.

This is because use of such a molding machine enables to obtain an antimicrobial fiber superior in surface smoothness efficiently.

### EXAMPLES

Hereinafter, the present invention will be described more in detail with reference to Examples. However, the following description is aimed at showing only examples of the present invention, and thus, the invention is not restricted by the description.

### Example 1

### 1. Melting Step

### Step A

Raw glass materials for an antimicrobial glass (composition A), respectively having a P₂O₅ component ratio of 50% by weight, a CaO component ratio of 5% by weight, a Na₂O component ratio of 1.5% by weight, a B₂O₃ component ratio of 10% by weight, an Ag₂O component ratio of 3% by weight, a CeO₂ component ratio of 0.5% by weight, and a ZnO component ratio of 30% by weight with respect to 100% by weight of the total weight of the glass, were mixed in a universal mixer at rotational frequency of 250 rpm for 30 minutes until homogeneity. The raw glass materials were then heated with a melting furnace at 1, 280° C. for 3 and half hours, to give a melt glass.

### 2. Pulverization Step

### Step B

Subsequently, the melt glass withdrawn from the glass melting furnace was fed into flowing water at 25° C. thereby to solidify and water-granulate the melt glass into a coarsely pulverized glass having an average particle size of approximately 10 mm. Observation of the coarsely pulverized glass in this phase under optical microscope confirmed that the glass was fragile bulky granules without sharp edges or faces.

Then, the coarsely pulverized glass was pulverized with a jaw crusher at a rotational frequency of 120 rpm (primary intermediate pulverization, average particle size: approximately 1,000 μm), while fed from a hopper by its dead load.

Then, the antimicrobial glass after primary intermediate pulverization was subjected to secondary intermediate pulverization in a revolving roll continuously under the condition of a gap of 1 mm, a rotational frequency of 30 rpm and additionally the condition of a gap of 0.25 mm and a rotational frequency of 30 rpm.

Observation of the coarsely pulverized glass after secondary intermediate pulverization under an electron microscope confirmed that at least 50% by weight or more of the glass granules were polyhedral with sharp edges and faces.

Then, silica particles (primary average particle size: 15 nm, secondary average particle size: 7 μm) were added in an amount of 7 parts by weight with respect to 100 parts by weight of the antimicrobial glass. Subsequently, by using a planetary mill equipped with a cyclone apparatus and a bug filter as a pulvelizer, the glass was finely pulverized under the processing condition described below. Then, the pulverization medium was separated after fine pulverization treatment, to give an antimicrobial glass carrying silica particles deposited thereon, i.e., an antimicrobial glass having an average particle size (D50) of 1.2 μm, a D90 value of 2.0 μm, and a specific surface area of 88,000 cm²/cm³.

Observation of the antimicrobial glass after the phase under an electron microscope confirmed that at least 95% by weight or more of the glass granules were polyhedral with sharp edges and faces, and that silica particles were present as deposited on the surface of the polyhedral antimicrobial glass.

Mill capacity: 4 liters
Diameter of pulverization medium: 20 mm
Kind of pulverization medium: alumina ball
Amount of pulverization medium: 4 kg
Antimicrobial glass: 1 kg
Rotational frequency: 56 rpm
Treatment period: 15 hours

### 3. Step of Producing Antimicrobial Fiber

### Step C

The polyhedral antimicrobial glass obtained was mixed with a polypropylene (PP) resin with a kneader under the condition of 25 Kg/10 minute at room temperature in an addition quantity of 0.3% by weight with respect to the total weight. The mixture was then processed with a BMC (bulk molding compound) injection molding machine at a cylinder temperature of 190° C., to give a fiber having a diameter of 10 μm.

### 4. Evaluation of Antimicrobial Fiber

Each of the antimicrobial glasses and the antimicrobial fibers shown in Table 1 was evaluated in the following tests.

### (1) Evaluation of Elution Amount

100 g of the antimicrobial glass obtained was immersed in 500 ml of distilled water (20° C.), and the mixture was shaken with a shaker for 24 hours. Then, an Ag ion eluate was separated by using a centrifugal separator and filtered additionally through a filter paper (5C), to give a test sample. Subsequently, the concentration of Ag ion in the test sample was determined by ICP emission spectroscopic analysis, and the amount of Ag ion eluted (mg/Kg/24 Hr) was calculated. The results obtained are summarized in Table 2.

### (2) Evaluation of Spinning Efficiency

The spinning efficiency of the antimicrobial fiber was evaluated according to the following criteria. The results obtained are summarized in Table 2.

Very good: Continuous spinning possible for 60 minutes or more
Good: Continuous spinning possible for 10 minutes or more
Fair: Continuous spinning possible for 1 minute or more
Bad: Continuous spinning not possible for 1 minute

### (3) Evaluation of Transparency

The antimicrobial fiber was observed under an optical microscope, and the transparency thereof was evaluated according to the following criteria. The results obtained are summarized in Table 2.

Very good: Transparent and colorless
Good: Partially opaque
Fair: Partially whitened
Bad: Completely whitened

### (4) Evaluation of Aggregation Resistance

The cross-sectional area of the antimicrobial fiber was observed under an electron microscope, and the aggregation resistance of the antimicrobial glass was evaluated from the mixing state and the surface state of the antimicrobial glass, according to the following criteria. The results obtained are summarized in Table 2.

Very good: Almost no aggregate observed, and the surface of antimicrobial fiber smooth
Good: Slight aggregation observed, but the surface of antimicrobial fiber almost smooth
Fair: Some aggregation and some surface irregularity of antimicrobial fiber observed
Bad: Frequent aggregation observed

### (5) Evaluation of Yellowing Tendency

The antimicrobial fiber obtained was irradiated continuously with an ultraviolet ray (black panel temperature: 63° C., illuminance: 255 W/m² with a light at a wavelength of 300 to 700 nm) by use of a UV irradiation equipment (Sunshine Weather Meter, manufactured by Suga Test Instrument Co., Ltd.), and the yellowing tendency of the antimicrobial fiber was evaluated according to the following criteria. The yellowing tendency of the antimicrobial fiber was observed under an optical microscope. The results obtained are summarized in Table 2.

Very good: Transparent and colorless after 100 hours
Good: Transparent and colorless after 50 hours
Fair: Transparent and colorless after 10 hours
Bad: Yellowed after 10 hours

### (6) Evaluation of Antimicrobial Action 1 to 2

10 g of an antimicrobial fiber was used in evaluation of the antimicrobial action. Separately, a test microbe was incubated on an agar flat plate medium of Trypticase Soy Agar (BBL) at 35° C. for 24 hours, and the colonies grown thereon was suspended in a 1/500-concentration normal bouillon medium (manufactured by Eiken Chemical Co., Ltd.), thereby to adjust the concentration to approximately 1×10⁶ CFU/ml.

Then, a 0.5 ml suspension of Staphylococcus aureus (Staphylococcus aureus IFO#12732) and a 0.5 ml suspension of E. coli (Escherichia coli ATCC#8739) were brought into contact with the antimicrobial fiber as the test piece respectively, and a polyethylene film (sterilization) was covered thereon, to give a test sample by the film cover method.

The test sample was then placed in a thermostatic oven under the condition of a humidity of 95% and a temperature of 35° C. for 24 hours. The cell counts (colony counts) before and after the test were determined, thereby to evaluate the antimicrobial activity 1 (Staphylococcus aureus) and the antimicrobial activity 2 (E. coli) according to the following criteria.

The cell counts (colony counts) before test were respectively 2.6×10⁵ (pieces/test piece) both for Staphylococcus aureus and E. coli. The results obtained are summarized in Table 2.

Very good: Cell count after test, less than 1/10000 of that before test
Good: Cell count after test, in the range of 1/10,000 or more and less than 1/1000 of that before test
Fair: Cell count after test, in the range of 1/1,000 or more and less than 1/100 of that before test.
Bad: Cell count after test, 1/100 or more of that before test

### Examples 2 to 4

In Examples 2 to 4, an antimicrobial glass was obtained and an antimicrobial fiber was prepared and evaluated in the same manner as in Example 1, except that the addition quantity of the dispersant silica particles (primary average particle size: 15 nm, secondary average particle size: 7 μm) was respectively changed to 5 parts by weight, 10 parts by weight, and 12 parts by weight with respect to 100 parts by weight of the antimicrobial glass.

Also in Examples 2 to 4, observation of the antimicrobial glass immediately after preparation under an electron microscope confirmed that at least 95% by weight or more of the granules were polyhedral with sharp edges and faces.

### Example 5

In Example 5, the glass composition of Example 1 (composition A) was used, a jet mill was used as a pulvelizer, and fine pulverization treatment was performed at an injection rate of 5 Kg/Hr under a pressure of 0.82 MPa, to give an antimicrobial glass having an average particle size (D50) of 2.5 μm and a specific surface area of 47,000 cm²/cm³.

Also in Example 5, observation of the antimicrobial glass after the phase under an electron microscope confirmed that at least 95% by weight or more of the granules were polyhedral with sharp edges and faces.

### Example 6

In Example 6, an antimicrobial glass having an average particle size (D50) of 10.9 μm and a specific surface area of 23,000 cm²/cm³ was obtained and an antimicrobial fiber was prepared and evaluated in the same manner as in Example 1, except that the glass composition of Example 1 (composition A) was used and the pulverization condition in the jet mill was changed to a pressure of 0.82 MPa and an injection rate of 30 Kg/Hr. However, the average particle size of the antimicrobial fiber was adjusted to 30 μm.

### Example 7

In Example 7, an antimicrobial glass was obtained and an antimicrobial fiber was prepared and evaluated in the same manner as in Example 1, except that the composition of the antimicrobial glass was changed. Namely, a polyhedron antimicrobial glass having an average particle size (D50) of 3.2 μm and a specific surface area of approximately 35,000 cm²/cm³ was obtained and an antimicrobial fiber was prepared and evaluated in the same manner as in Example 1, except that used was a mixture having a P₂O₅ component ratio of 59.6% by weight, a CaO component ratio of 26.3% by weight, a Na₂O component ratio of 0.6% by weight, a B₂O₃ component ratio of 10% by weight, an Ag₂O component ratio of 3% by weight, and a CeO₂ component ratio of 0.5% by weight with respect to the total weight.

### Comparative Example 1

In Comparative Example 1, the glass composition of Example 1 (composition A) was used, and the glass was treated with a planetary mill equipped with a cyclone apparatus and a bug filter for only 3 hours, to give an antimicrobial glass having an average particle size (D50) of 15 μm. However, no antimicrobial fiber having a diameter of 10 μm similarly to that in Example 1 was obtained, because the average particle size of the antimicrobial glass was too large for favorable spinning. Thus, an antimicrobial fiber having a diameter of 50 μm was prepared and evaluated, similarly to Example 1.

### Comparative Example 2

In Comparative Example 2, a glass composition (composition B) different from that in Example 1 was used, and the glass was treated with a planetary mill equipped with a cyclone apparatus and a bug filter for only 3 hours, to give an antimicrobial glass having an average particle size (D50) of 15 μm. However, no antimicrobial fiber having a diameter of 10 μm was prepared, similarly to Example 1, because the average particle size of the antimicrobial glass was too large for favorable spinning.

Thus, an antimicrobial fiber having a diameter of 50 μm was prepared, and evaluated similarly to Example 1.

### Comparative Example 3

In Comparative Example 3, an antimicrobial glass was prepared in the same manner as in Example 1, except that no silica particle was added as the dispersant. However, the antimicrobial glass deposited on the internal wall of the ball mill and could not be separated, forcing discontinuation of the test.

### Comparative Example 4

In Comparative Example 4, the glass was treated with a wet ball mill for an elongated period of 100 hours or more, in an attempt to give an antimicrobial glass having an average particle size (D50) of 10 μm or less. However, the antimicrobial glass deposited on the internal wall of the ball mill and could not be separated easily. In addition, the separated antimicrobial glass aggregated after heating and drying, giving large particles and thus forcing discontinuation of the test.

TABLE 1

| | | | Antimicrobial glass | | | | | |
|---|---|---|---|---|---|---|---|---|
| | | | Average | Specific | | Silica particles | | Antimicrobial |
| | | | particle | surface | Addition | Average | Addition | fiber |
| | Glass | | size | area | quantity | particle size | quantity | Diameter |
| | composition | Pulvelizer | (um) | (cm²/cm³) | (wt %) | (um) | (wt %) | (um) |
| Example 1 | A | Planetary | 1.2 | 88000 | 0.3 | 7 | 7 | 10 |
| | | mill | | | | | | |
| Example 2 | A | Planetary | 2.0 | 59000 | 0.3 | 7 | 5 | 10 |
| | | mill | | | | | | |
| Example 3 | A | Planetary | 1.2 | 89000 | 0.3 | 7 | 10 | 10 |
| | | mill | | | | | | |
| Example 4 | A | Planetary | 1.1 | 93000 | 0.3 | 7 | 12 | 10 |
| | | mill | | | | | | |
| Example 5 | A | Jet mill | 2.5 | 47000 | 0.3 | 7 | 7 | 10 |
| Example 6 | A | Jet mill | 10.9 | 23000 | 0.3 | 7 | 7 | 30 |
| Example 7 | B | Ball mill | 3.2 | 35000 | 0.3 | 7 | 7 | 10 |
| Comparative | A | Planetary | 15.0 | 11000 | 0.3 | None | None | 50 |
| Example 1 | | mill | | | | | | |
| Comparative | B | Planetary | 15.0 | 10000 | 0.3 | None | None | 50 |
| Example 2 | | mill | | | | | | |

| | | | | | |
|---|---|---|---|---|---|
| Comparative | A | Ball mill | Not evaluated | Not evaluated | Not evaluated |
| Example 3 | | | | | |
| Comparative | A | Ball mill | Not evaluated | Not evaluated | Not evaluated |
| Example 4 | | | | | |

TABLE 2

| | | | | | | Antimicrobial | |
|---|---|---|---|---|---|---|---|
| | Elution | | | | | activity 1 | Antimicrobial |
| | amount | Spinning | | Aggregation | Yellowing | (Staphylococcus | activity 2 |
| | (mg/Kg/24 h) | efficiency | Transparency | resistance | tendency | aureus) | (E. coli) |
| Example 1 | 7100 | Very good | Very good | Very good | Very good | Good | Very good |
| Example 2 | 4300 | Good | Good | Fair | Good | Good | Very good |
| Example 3 | 7000 | Very good | Good | Good | Very good | Good | Very good |
| Example 4 | 7900 | Very good | Good | Good | Very good | Good | Very good |
| Example 5 | 4100 | Good | Good | Fair | Good | Good | Very good |
| Example 6 | 1200 | Fair | Fair | Fair | Fair | Fair | Very good |
| Example 7 | 3800 | Good | Good | Very good | Good | Good | Very good |
| Comparative | 890 | Bad | Bad | Bad | Bad | Bad | Bad |
| Example 1 | | | | | | | |
| Comparative | 890 | Bad | Bad | Bad | Bad | Bad | Bad |
| Example 2 | | | | | | | |
| Comparative | Not | Not | Not | Not | Not | Not evaluated | Not evaluated |
| Example 3 | evaluated | evaluated | evaluated | evaluated | evaluated | | |
| Comparative | Not | Not | Not | Not | Not | Not evaluated | Not evaluated |
| Example 4 | evaluated | evaluated | evaluated | evaluated | evaluated | | |

As described above, according to the present invention, it is possible to obtain an antimicrobial glass for use in production of an antimicrobial fiber having a diameter of approximately 10 to 30 μm reliably, by using inorganic particles in combination as the dispersant of the antimicrobial glass and controlling the average particle size of the antimicrobial glass, addition quantity, and others in predetermined ranges.

Thus, according to the present invention, use of a pulvelizer such as a planetary mill or a jet mill, in particular, a dry pulverizer makes it possible to efficiently and reliably obtain an antimicrobial glass superior in dispersibility, production stability and others efficiently and an antimicrobial fiber superior in surface smoothness and transparency.

Because the antimicrobial fiber according to the invention contains inorganic particles as the dispersant of the antimicrobial glass in a predetermined amount. When the inorganic particles are hydrophilic, the solubilization rate of the antimicrobial glass became constant and the color-developing efficiency as the antimicrobial fiber was also favorable.

Inorganic particles are often added to an antimicrobial fiber for improvement in strength and others, but the antimicrobial fiber according to the invention, which contains inorganic particles as the dispersant of the antimicrobial glass, eliminates such post addition of inorganic particles or reduces the addition quantity. Thus, it is possible practically to eliminate the post-addition step and to prevent the troubles in spinning caused by post-addition of inorganic particles, and others.

1. An antimicrobial fiber comprising a transparent resin, an antimicrobial glass, and inorganic particles as a dispersant of the antimicrobial glass, wherein
a diameter of the antimicrobial fiber is in the range of 10 to 30 μm,
an average particle size of the antimicrobial glass is in the range of 0.1 to 10 μm, and an addition quantity of the antimicrobial glass is in the range of 0.1 to 10% by weight with respect to the total weight, and
an average particle size of the inorganic particles is in the range of 1 to 15 μm, and an addition quantity of the inorganic particles is in the range of 0.1 to 50 parts by weight with respect to 100 parts by weight of the addition quantity of the antimicrobial glass.

2. The antimicrobial fiber according to claim 1, wherein the inorganic particles are aggregated silica particles.

3. The antimicrobial fiber according to claim 1, wherein a specific volume resistivity of the inorganic particles is in the range of 1×10⁵ to 1×10⁹ Ω·cm.

4. The antimicrobial fiber according to claim 1, wherein a visible light transmittance of the antimicrobial fiber is 90% or more.

5. The antimicrobial fiber according to claim 1, wherein a specific surface area of the antimicrobial glass is in the range of 10,000 to 300,000 cm²/cm³.

6. The antimicrobial fiber according to claim 1, wherein, when an average particle size of the antimicrobial glass is indicated by 50% volume particle size (D50), a 90% volume particle size (D90) is in the range of 0.5 to 12 μm and a ratio of D90/D50 is in the range of 1.1 to 2.0.

7. The antimicrobial fiber according to claim 1, wherein the antimicrobial glass is surface-treated with a silane coupling agent containing a long-chain alkyl group having 5 or more carbon atoms, with a hydrophobic group formed on the surface thereon.

8. A method for producing an antimicrobial fiber comprising a transparent resin, an antimicrobial glass, and inorganic particles as a dispersant of the antimicrobial glass, the method comprising the following steps (A) to (D):
a step (A) of preparing a glass by melting and cooling raw glass materials containing an antimicrobial ion-releasing substance;
a step (B) of preparing an inorganic particle-added antimicrobial glass by pulverizing the obtained glass with a pulvelizer, together with inorganic particles having an average particle size of 1 to 15 μm as a dispersant for the antimicrobial glass, into the antimicrobial glass having an average particle size of 0.1 to 10 μm;
a step (C) of dispersing the obtained inorganic particle-added antimicrobial glass in a transparent resin; and
a step (D) of spinning the mixture into an antimicrobial fiber having a diameter of 10 to 30 μm.

9. The method for producing an antimicrobial fiber according to claim 8, wherein the pulvelizer is a wet ball mill, a dry ball mill, a planetary mill, a vibrating mill or a jet mill.

10. The method for producing an antimicrobial fiber according to claim 8, wherein the pulvelizer is equipped with a cyclone, and the inorganic particle-added antimicrobial glass is produced while circulated with the cyclone.
